(19) United States
(12) Patent Application Publication
(10) Pub. No.: US 2018/0359090 A1
(43) Pub. Date: Dec. 13, 2018

(54) AVOIDING LINK INTEGRITY FAILURES ON DISPLAYPORT DURING HCDP 2.2 BY USING SINK SIDE OPTIMIZATIONS

(71) Applicant: QUALCOMM Incorporated, San Diego, CA (US)

(72) Inventors: Ashish GROVER, Carlsbad, CA (US); Shivaprasad HONGAL, San Diego, CA (US); Bollapragada V.J. MANOHAR, San Diego, CA (US)

(21) Appl. No.: 15/618,103

(22) Filed: Jun. 8, 2017

(51) Int. Cl. H04L 9/32; H04L 29/06; H04L 9/06; H04L 9/08; H04L 9/14

(52) U.S. Cl. CPC H04L 9/32; H04L 63/0428; H04L 9/14; H04L 9/0894; H04L 9/0631

(57) ABSTRACT

Techniques for operating a receiver are provided. An example method according to these techniques includes receiving a content type indicator from a transmitter indicating that a content stream from the transmitter comprises a first content type, performing a first integrity check on the content stream by decrypting content from the content stream based in part on the content type indicator, incrementing a counter responsive to the first integrity check failing due to a mismatch between the content type indicator and the content of the content stream, performing a second integrity check on the content stream by decrypting the content from the content stream based in part on a second content type responsive to the counter exceeding a threshold, and decrypting the content stream based in part on the second integrity check being successful.

### BACKGROUND

Digital Content Protection schemes such as High-bandwidth Digital Content Protection (HDCP) prevents the copying of digital audio and video content while the content travels across connections between a transmitter and a receiver. HDCP can be used with various types of connects, such as DisplayPort (DP), Digital Visual Interface (DVI), and High-Definition Multimedia Interface (HDMI). HDCP protects digital content in several ways. First, authentication is used to prevent non-licensed devices from receiving protected content. Second, digital content transmitted from the transmitter to the receiver is encrypted to prevent eavesdropping and/or man-in-the middle attacks. Third, key revocation is utilized to prevent devices that have been compromised from receiving protected data.

### SUMMARY

An example method according to the disclosure includes receiving a content type indicator from a transmitter indicating that a content stream from the transmitter comprises a first content type, performing a first integrity check on the content stream by decrypting content from the content stream based in part on the content type indicator, incrementing a counter responsive to the first integrity check failing due to a mismatch between the content type indicator and the content of the content stream, performing a second integrity check on the content stream by decrypting the content from the content stream based in part on a second content type responsive to the counter exceeding a threshold, and decrypting the content stream based in part on the content stream comprising the second content type responsive to the second integrity check being successful.

Implementations of such a method can include one or more of the following features. The content type indicator indicates whether the content stream comprises premium content. The content stream is encrypted using High-bandwidth Digital Content Protection (HDCP). The content stream is encrypted with a version 2.2 of HDCP or higher. Performing the first integrity check on the content stream by decrypting the content from the content stream based in part on the content type indicator includes comparing a portion of the decrypted content to a link verification pattern associated with a content type indicated by the content type indicator, and determining that the first integrity check has failed responsive to the portion of the decrypted content not matching the link verification pattern. Performing the second integrity check on the content stream by decrypting the content from the content stream based on part on the second content type includes comparing a portion of the decrypted content to a link verification pattern associated with the second content type, and determining that the second integrity check has failed responsive to the portion of the decrypted content not matching the link verification pattern. Sending a reauthentication request to the transmitter responsive to the second integrity check being successful and a second content indicator not being received from the transmitter indicating that the content stream comprises content of the second content type. Sending the reauthentication request to the transmitter further comprises setting a timer responsive to the second integrity check being successful, determining that the second content indicator has not been received prior to expiration of the timer, and sending the reauthentication request responsive to the second content indicator not being received from the transmitter prior to the expiration of the timer.

An example receiver according to the disclosure includes means for receiving a content type indicator from a transmitter indicating that a content stream from the transmitter comprises a first content type, means for performing a first integrity check on the content stream by decrypting content from the content stream based in part on the content type indicator, means for incrementing a counter responsive to the first integrity check failing due to a mismatch between the content type indicator and the content of the content stream, means for performing a second integrity check on the content stream by decrypting the content from the content stream based in part on a second content type responsive to the counter exceeding a threshold, and means for decrypting the content stream based in part on the second integrity check being successful.

Implementations of such a receiver can include one or more of the following features. The content type indicator indicates whether the content stream comprises premium content. The content stream is encrypted using High-bandwidth Digital Content Protection (HDCP) and version 2.2 of the HDCP protocol or higher. The means for performing the first integrity check on the content stream by decrypting the content from the content stream based in part on the content type indicator includes means for comparing a portion of the decrypted content to a link verification pattern associated with a content type indicated by the content type indicator, and means for determining that the first integrity check has failed responsive to the portion of the decrypted content not matching the link verification pattern. The means for performing the second integrity check on the content stream by decrypting the content from the content stream based on part on the second content type includes means for comparing a portion of the decrypted content to a link verification pattern associated with the second content type, and means for determining that the second integrity check has failed responsive to the portion of the decrypted content not matching the link verification pattern. Means for sending a reauthentication request to the transmitter responsive to the second integrity check being successful and a second content indicator not being received from the transmitter indicating that the content stream comprises content of the second content type. The means for sending the reauthentication request to the receiver further comprises means for setting a timer responsive to the second integrity check being successful, means for determining that the second content indicator has not been received prior to expiration of the timer, and means for sending the reauthentication request responsive to the second content indicator not being received from the transmitter prior to the expiration of the timer.

An example receiver according to the disclosure includes a memory and a processor communicatively coupled to the memory. The processor is configured to receive a content type indicator from a transmitter indicating that a content stream from the transmitter comprises a first content type, perform a first integrity check on the content stream by decrypting content from the content stream based in part on the content type indicator, increment a counter responsive to the first integrity check failing due to a mismatch between the content type indicator and the content of the content stream, perform a second integrity check on the content stream by decrypting the content from the content stream based in part on a second content type responsive to the counter exceeding a mismatch threshold, and decrypt the content stream based in part on the second integrity check being successful.

Implementations of such a receiver can include one or more of the following features. The content type indicator indicates whether the content stream comprises premium content. The processor being configured to perform the first integrity check on the content stream by decrypting content from the content stream based in part on the content type indicator further is further configured to compare a portion of the decrypted content to a link verification pattern associated with a content type indicated by the content type indicator, and determine that the first integrity check has failed responsive to the portion of the decrypted content not matching the link verification pattern. The processor being configured to perform the second integrity check on the content stream by decrypting content from the content stream based on part on the second content type is further configured to compare a portion of the decrypted content to a link verification pattern associated with the second content type, and determine that the second integrity check has failed responsive to the portion of the decrypted content not matching the link verification pattern. The processor is further configured to send a reauthentication request to the transmitter responsive to the second integrity check being successful and a second content indicator not being received from the transmitter indicating that the content stream comprises content of the second content type. The processor being configured to send the reauthentication request is further configured to set a timer responsive to the second integrity check being successful, determine that the second content indicator has not been received prior to expiration of the timer, and send the reauthentication request responsive to the second content indicator not being received from the transmitter prior to the expiration of the timer.

An example non-transitory, computer-readable medium according to the disclosure has stored thereon computer-readable instructions operating for operating a receiver. The instructions include instructions configured to cause the receiver to receive a content type indicator from a transmitter indicating that a content stream from the transmitter comprises a first content type, perform a first integrity check on the content stream by decrypting content from the content stream based in part on the content type indicator, increment a counter responsive to the first integrity check failing due to a mismatch between the content type indicator and content of the content stream, perform a second integrity check on the content stream by decrypting content from the content stream based in part on a second content type responsive to the counter exceeding a threshold, and decrypt the content stream based in part on the second integrity check being successful.

Implementations of such a non-transitory, computer-readable medium can include one or more of the following features. The content type indicator indicates whether the content stream comprises premium content. The content stream is encrypted using High-bandwidth Digital Content Protection (HDCP) and version 2.2 of the HDCP protocol or higher. The instructions configured to cause the receiver to perform the first integrity check on the content stream by decrypting content from the content stream based in part on the content type indicator include instructions configured to cause the receiver to compare a portion of the decrypted content to a link verification pattern associated with a content type indicated by the content type indicator, and determine that the first integrity check has failed responsive to the portion of the decrypted content not matching the link verification pattern. The instructions configured to cause the receiver to perform the second integrity check on the content stream by decrypting content from the content stream based on part on the second content type include instructions configured to cause the receiver to compare a portion of the decrypted content to a link verification pattern associated with the second content type, and determine that the second integrity check has failed responsive to the portion of the decrypted content not matching the link verification pattern. Instructions configured to cause the receiver to send a reauthentication request to the transmitter responsive to the second integrity check being successful and a second content indicator not being received from the transmitter indicating that the content stream comprises content of the second content type. The instructions configured to cause the receiver to send the reauthentication request to the transmitter include instructions configured to cause the receiver to: set a timer responsive to the second integrity check being successful, determine that the second content indicator has not been received prior to expiration of the timer, and send the reauthentication request responsive to the second content indicator not being received from the transmitter prior to the expiration of the timer.

### BRIEF DESCRIPTION OF THE DRAWINGS

FIG. 1 is a schematic diagram of an example topography in which the techniques disclosed herein can be implemented.

FIG. 2 is a block diagram of an example computing device that can be used to implement the transmitter, repeater, and/or the receiver illustrated in FIG. 1.

FIG. 3 is a flow chart of an example process for operating a receiver according to the techniques disclosed herein.

FIG. 4 is a flow chart of an example process for performing an integrity check on digital content at a receiver according to the techniques disclosed herein.

FIG. 5 is a flow chart of an example process for performing an integrity check on digital content at a receiver according to the techniques disclosed herein.

FIG. 6 is a flow chart of an example process for performing reauthentication between the receiver or repeater and the transmitter according to the techniques disclosed herein.

FIG. 7 is a flow chart of an example process for performing reauthentication between the receiver or repeater and the transmitter according to the techniques disclosed herein.

Like reference symbols in the various drawings indicate like elements, in accordance with certain example implementations.

### DETAILED DESCRIPTION

Described herein are methods, systems, devices, computer readable media, and other implementations, for providing an improved user experience when streaming protected digital content. A situation that can negatively impact the user experience can occur when the transmitter switches between transmitting premium and non-premium content. The transmitter can be configured to communicate a content type indicator to the receiver that identifies the digital content being transmitted to the receiver as premium content or non-premium content. However, the receiver may not receive this content type indicator prior to receiving the digital content in some instances. For example, the content type changes once the transmitter has begun transmitting digital content to the receiver. This mismatch can cause the receiver to be unable to decrypt the content and can cause the receiver to notify the transmitter that a link integrity error has occurred. The playback of the digital content at the receiver may then be interrupted for a short period of time while the transmitter and the receiver reauthenticate with one another. The techniques disclosed herein can be used to avoid this problem and to provide a better user experience in which playback of the digital content is not interrupted.

The techniques disclosed herein can be used with digital content protection schemes such as HDCP on various types of connections, including but not limited to HDCP version 2.2 on DisplayPort version 1.3. HDCP 2.2 on DisplayPort 1.3 utilizes a shared type value that serves as a content type indicator for the transmitter and the receiver or for the transmitter and the repeater where a repeater is utilized. The content type indicator is used to indicate whether the digital content being transmitted to the receiver or the repeater includes premium or non-premium content. Premium content may comprise content that is paid content or content that requires more or stronger protection than non-premium content. The content type indicator is determined by an Upstream Content Control Function. Audiovisual content flows from this Upstream Content Control Function into the transmitter, which in turn encrypts the digital content using HDCP encryption and transmits the encrypted content to the receiver or repeater downstream from the transmitter. The HCDP DisplayPort specification does not describe how to propagate a change in type from the transmitter to the downstream receiver or repeater once the HDCP encryption is active. The content type indicator is used by the HDCP encryption unit of the transmitter and the HDCP decryption unit of the receiver. The type information can be transmitted to the receiver out of band from the digital content being transmitted using HDCP. If the receiver has not been informed of the content type change prior to receiving the content in which a change of type has occurred, the receiver can decrypt the content using the wrong type value causing integrity check performed by the receiver to fail. The receiver can then inform the transmitter that a link integrity error has occurred, which can result in the transmitter and the receiver performing reauthentication. The reauthentication process is not instantaneous. During the time that this process is undertaken, the playback of the digital content stream by the receiver can be interrupted. The receiver may output a blank data stream during this time. The viewer may experience a blank or black screen on a display while the transmitter and receiver are reauthenticated and the digital content stream is restarted.

Link integrity checks are periodically performed by the receiver to ensure that cipher synchronization between the transmitter and the receiver is maintained. In HDCP 2.2 on DisplayPort 1.3, the transmitter encrypts a known bit pattern and sends this known bit pattern to the receiver. According to the HDCP 2.2 on DisplayPort 1.3 specification, the known bit pattern comprises a 16 bit pattern that is transmitted from the transmitter to the receiver one bit at a time. This pattern is referred to as the LINK_VERIFICATION_PATTERN and is transmitted as bit 5 of a vertical blank ID packet (VB-ID) transmitted when Single Stream Transport (SST) mode is being used. The LINK_VERIFICATION_PATTERN pattern is also transmitted when the multi-stream (MST) mode is being used. The receiver can be configured to decrypt the encrypted bit pattern received from the transmitter and to compare the decrypted value to an expected value. If a mismatch occurs more than a predetermined number of times, then the receiver can be configured to trigger a link integrity failure, which signals the transmitter to reauthenticate with the receiver. According to the HDCP 2.2 on DisplayPort 1.3 specification, this fixed pattern is checked four times per frame. If a mismatch occurs for two consecutive frames, the receiver is configured to trigger a link integrity failure. The specific examples for transmitting a link verification pattern, the frequency at which the receiver verifies the pattern, and the threshold for triggering a link integrity failure are examples and are not intended to limit the scope of the disclosure to these specific examples.

The following examples are example scenarios where a content type change may occur in HDCP on DP implementations:
The start of playback of digital rights management (DRM) content premium content that requires HDCP 2.2 or higher (content type switches from 0 to 1);
The end of playback of DRM premium content to non-premium content (content type switches from 1 to 0); and
During DRM content playback, updated licensing information causes type to change from premium to non-premium content or vice versa (content type switches from 1 to 0 or from 0 to 1).
The preceding example scenarios are not exhaustive and other scenarios may exist where content type changes may occur.

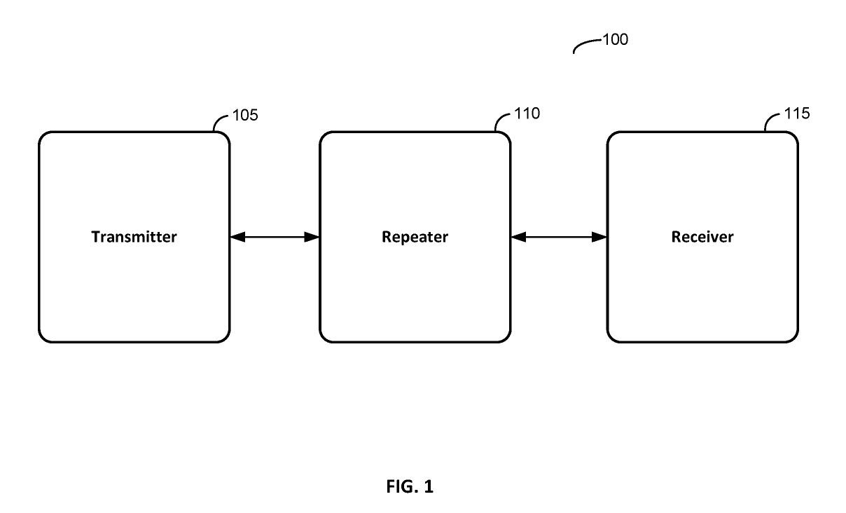

FIG. 1 is a schematic diagram of an example device topology 100 in which the techniques disclosed herein can be implemented. The example topography of FIG. 1 includes a transmitter 105, a repeater 110, and a receiver 115. The transmitter 105 is configured to transmit encrypted digital content to one or more downstream devices through a protected interface port. The downstream devices in this example implementation include a repeater 110 and a receiver 115. One or more repeaters may be disposed between the transmitter 105 and the receiver 115, and one or more receivers may be connected to the transmitter 105 or to a repeater 110. The inclusion of one or more repeaters is optional and the transmitter 105 can be communicatively coupled to the receiver 115. The receiver 115 is configured to receive, via a protected interface port, encrypted content transmitted by the transmitter 105 and to decrypt the received content. The receiver 115 can be integrated into a device capable of outputting audiovisual content, such as but not limited to a television, monitor, or a laptop or tablet computer. The repeater 110 is configured to receive encrypted content from the transmitter 105 or another repeater 110 upstream from the repeater 110. The repeater 110 is configured to decrypt the received encrypted content, decrypt the content, to reencrypt the content, and to transmit the reencrypted content to a downstream device via a protected interface port.

The transmitter 105, a repeater 110, and a receiver 115 may be configured to operate using different versions of a content protection protocol. For example, each of these devices may be configured to support HDCP 2.2 or higher on DisplayPort 1.3 or another particular version of a content protection protocol. However, one or more of these devices may not be capable of supporting a particular version of the content protection protocol. As a result, a content types that require a particular version or higher of the content protection protocol may not be transmitted to a device that does not support that particular version or higher of the content protection protocol. For example, in HDCP on DP, premium content can only be transmitted to a device that supports HDCP 2.2 or higher on DP. Other content protection protocols may have similar restrictions on which content types can be transmitted using a particular version or versions of the content protection protocol.

The receiver 115 can be configured to report to an upstream device (e.g., a repeater 110 or the transmitter 105) which version of the content protection protocol that the receiver 115 is capable of supporting. The repeater 110 can be configured to collect information from downstream devices, such as one or more the receivers and one or more repeaters (which may optionally be included in the topology) as to which version of the content protection protocol is supported by each of the devices and to send that information to the transmitter 105 or to an upstream repeater which can in turn forward this information further upstream to the transmitter 105. The transmitter 105 can be configured to use the downstream device information to determine whether a first content type that requires a particular version of the content protection protocol, such as HDCP 2.2 or higher (or another content protection protocol), to be supported in all devices in the topology in order to be transmitted can be transmitted. If one or more of the downstream devices do not support the particular version or higher of the content protection protocol required for a particular content type, the transmitter 105 can be configured to modify the digital content such that the digital content can be sent to the downstream devices that do not support the particular version of the content protection protocol. For example, the audio and/or video quality of the digital content can be decreased prior to transmitting the first content type where one or more of the downstream devices do not support the particular version of the content protection protocol. The transmitter 105 can also be configured to not transmit first content type content to devices not supporting the required version of the content protection protocol or to transmit blank content or content comprising a message indicating that a downstream device does not support the minimum version of content protection protocol required to receive the first content type.

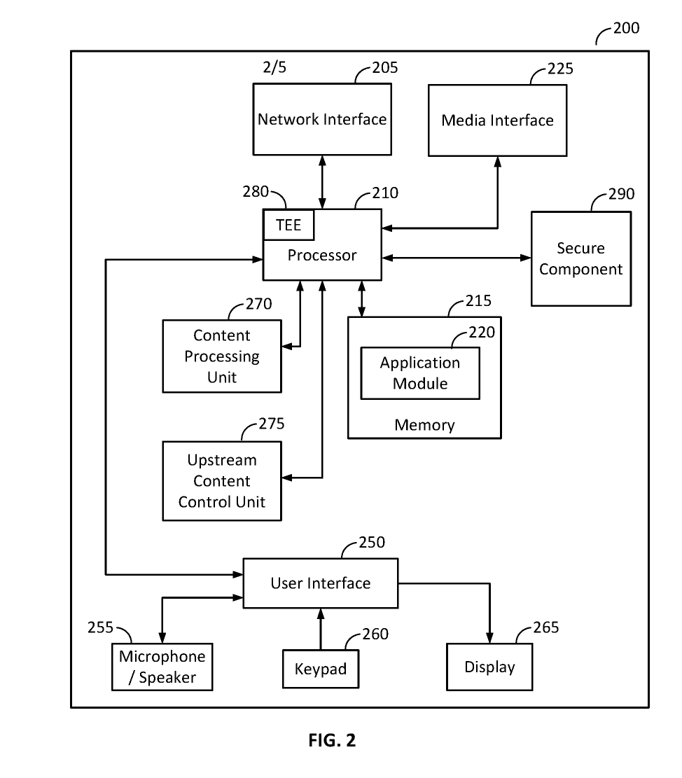

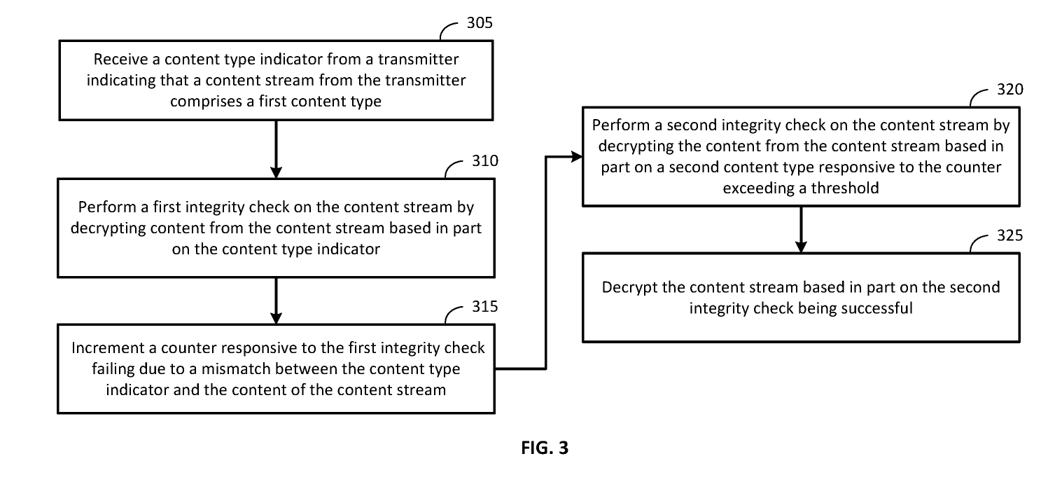

FIG. 2 is a block diagram of an example computing device 200 that can be used to implement the transmitter 105, repeater 110, and/or the receiver 115 illustrated in FIG. 1. The computing device 200 can be used to implement, at least in part, the processes illustrated in FIGS. 3-6. FIG. 2 is a schematic diagram illustrating various components of an example computing device 200. For the sake of simplicity, the various features/components/functions illustrated in the schematic boxes of FIG. 2 are connected together using a common bus to represent that these various features/components/functions are operatively coupled together. Other connections, mechanisms, features, functions, or the like, can be provided and adapted as necessary to operatively couple and configure a device capable of sending and/or receiving streaming content. The device may be a portable device, such as a smartphone, tablet or laptop computer, or may be a device that may be moveable but substantially is substantially stationary, such as a streaming digital video content player, a digital video media player (such as a BLURAY or other media player), or other such device. Furthermore, one or more of the features or functions illustrated in the example of FIG. 2 can be further subdivided, or two or more of the features or functions illustrated in FIG. 2 can be combined. Additionally, one or more of the features or functions illustrated in FIG. 2 can be excluded.

As shown, the computing device 200 can include a network interface 205 that can be configured to provide wired and/or wireless network connectivity to the computing device 200. The network interface can include one or more local area network transceivers that can be connected to one or more antennas. The one or more local area network transceivers comprise suitable devices, circuits, hardware, and/or software for communicating with and/or detecting signals to/from one or more of the WLAN access points, and/or directly with other wireless devices within a network. The network interface 205 can also include, in some implementations, one or more wide area network transceiver(s) that can be connected to the one or more antennas. The wide area network transceiver can comprise suitable devices, circuits, hardware, and/or software for communicating with and/or detecting signals from one or more of, for example, the WWAN access points and/or directly with other wireless devices within a network. The network interface 205 is optional and may not be included in some implementations of the transmitter 105, repeater 110, and/or the receiver 115, which may not require network connectivity.

The computing device 200 can also include a media interface 225. The media interface 225 is a communication interface and can comprise one or more ports for receiving and/or transmitting digital content. The digital content can be encrypted and may be protected using one or more digital content protection protocols, such as HDCP. The media interface 225 can include one or more types of digital display interface that can be used to connect the computing device 200 to another computing device that is configured to transmit and/or receive digital content. The media interface 225 can include interface ports for one or more of DisplayPort (DP), Digital Visual Interface (DVI), and High-Definition Multimedia Interface (HDMI). The media interface 225 can also be configured to support other types of digital audiovisual interfaces in addition to or instead of one or more of the example types of digital audiovisual interface discussed herein.

The processor 210 can be connected to the network interface 205, the media interface 225 and/or other components of the computing device 200. The processor can include one or more microprocessors, microcontrollers, and/or digital signal processors that provide processing functions, as well as other calculation and control functionality. The processor 210 can be coupled to storage media (e.g., memory) 215 for storing data and software instructions for executing programmed functionality within the computing device 200. The memory 215 can be on-board the processor 210 (e.g., within the same IC package), and/or the memory can be external memory to the processor and functionally coupled over a data bus. The processor can also be coupled to a content processing unit 270 and/or an upstream content control unit 275. The content processing unit 270 and the upstream content control unit 275 can be implemented as software, hardware, or a combination thereof. The content processing unit 270 and/or the upstream content control unit 275 can be implemented one or more application specific integrated circuits (ASICs), programmable logic devices (PLDs), field programmable gate arrays (FPGAs), or other electronic units designed to perform the functions described herein, or a combination thereof. The content processing unit 270 and/or the upstream content control unit 275 can be implemented, at least in part, by processor executable program code. Such processor-executable program code may be stored and/or executed by the trusted execution environment 280 or the secure component 290 described below.

The computing device 200 can include an upstream content control unit 275 where the computing device 200 is configured to function as a transmitter of digital content, such as the transmitter 105 of FIG. 1. Digital audiovisual content flows from the upstream content control unit 275 to the content processing unit 270, which is configured to encrypt the digital content according to a content protection protocol, including but not limited to HDCP, and to transmit the encrypted content to one or more downstream devices, such as the receiver 115 or the repeater 110 illustrated in FIG. 1. The upstream content control unit 275 is configured to emit unencrypted digital audiovisual content that requires content protection while being communicated between the transmitter and the receiver and/or repeater. The upstream content control unit 275 can comprise hardware and/or executable software components (executable by the processor 210) which emit audiovisual content to be protected by the content protection protocol. The upstream content control unit 275 is configured to determine a content type of the digital content. For example, in HDCP on DP implementations, the upstream content control unit 275 is configured to determine whether the digital content is premium content or non-premium content and can notify the content processing unit 270. The type of content being provided by the upstream content control unit 275 included in a stream can change from premium to non-premium content or vice versa. The upstream content control unit 275 can be configured to receive updates to content licensing, which can prompt the upstream content control unit 275 to change the content type of the content being provided to the upstream content control unit 275.

The content processing unit 270 can be configured to encrypt digital content to be transmitted to a receiver or repeater, such as the receiver 115 or the repeater 110 illustrated in FIG. 1. The content processing unit 270 can be configured to receive digital content from the upstream content control unit 275 as discussed above, and the content processing unit 270 can be configured to receive digital content from more than one upstream content control unit. The content processing unit 270 can be configured to encrypt and transmit the digital content according to the HDCP protocol and/or other content protection protocol. The content processing unit 270 can also be configured receive an indication of the type of content being received from the upstream content control unit 275. For example, the upstream content control unit 275 can be configured to provide an indication whether the digital content being provided to the content processing unit 270 comprises a first content type or a second content type, such as premium content or non-premium content in HDCP on DP implementations. The content processing unit 270 can also be configured to propagate a content type indicator to one or more downstream devices that identifies the type of content being transmitted to the downstream devices. The transmitter and the downstream devices can be configured to handle different types of content differently. For example, in HDCP on DP implementations, the transmitter and the downstream devices can be configured to handle premium and non-premium content differently. For example, where the content processing unit 270 is part of a transmitter or repeater, the content processing unit 270 may be configured to not transmit premium content to a downstream device that does not support at least a minimum version of the content protection protocol or may be configured to downgrade the quality of the content prior to transmission where one or more of the downstream devices do not support the particular version of the content protection protocol required for premium content.

The content processing unit 270 can also be configured to decrypt encrypted digital content received from an upstream device, such as the transmitter 105 or the repeater 110 of FIG. 1. The content processing unit 270 can also be configured to perform integrity checks on the link between an upstream transmitter and computing device 200. For example, the content processing unit 270 of the transmitter can be configured to send an encrypted link verification pattern to the receiver. The content processing unit 270 of the receiver can be configured to decrypt the link verification pattern and compare the decrypted value to a reference value to determine whether the two values match. A mismatch can indicate that that cipher synchronization between the transmitter and the receiver has been lost. Cipher synchronization between the transmitter and the receiver may be lost when the content processing unit 270 of the transmitter has changed the type of content being transmitted (e.g. from premium content to non-premium content or vice versa), but the downstream devices do not receive an indication that the type of content has changed prior to receiving the new type of content.

The content processing unit 270 of the transmitter 105 can be configured to encrypt the content based at least in part on the type of content being encrypted. Thus, the encryption of the link verification pattern is dependent in part on the content type, and the receiver 115 or the repeater 110 attempting to decrypt the content will need to know the content type in order to property decrypt the encrypted content and the link verification pattern. For example, in implementations that utilize HDCP 2.2 on DP 1.3, the HDCP cipher consists of a 128-bit Advance Encryption Standard (AES) module configured to operate in the Counter (CTR) mode. The CTR mode cause the AES block cipher to operate as a stream cipher in which the digital content to be encrypted with a pseudorandom cipher digit stream referred to as a keystream. One input to the AES-CTR module is an initialization vector (IV). The value of the IV is based at least in part on the content type of the content to be transmitted. One or more bits of the IV vector can be set based on the type of content to be transmitted. Changing the IV value changes the output of the encryption module. A receiver 115 or repeater 110 attempting to decrypt the content will need to know the content type in order to be able to decrypt the encrypted content.

The content processing unit 270 of the transmitter 105 can be configured to send a content type indicator to downstream devices indicating that the transmitter is about to transmit a content of a new type, such as switching to from premium content to non-premium content or vice versa. However, a downstream device may not receive the content type indicator prior to receiving digital content of a type not expected by the receiver 115 or repeater 110, and the content processing unit 270 of the downstream device may attempt to decrypt the encrypted content using the IV value. Alternatively, the downstream device may receive the content type indicator prior to receiving the digital content of the type indicated by the content indicator, and the content processing unit 270 of the downstream device may attempt to decrypt the encrypted content using the wrong IV value. The content processing unit 270 of the downstream device can be configured to trigger a link integrity failure responsive to the link verification pattern included in the encrypted content not matching the expected reference value more than a predetermined number of times. The content processing unit 270 of the receiver 115 or the repeater 110 can be configured to use the processes illustrated in FIGS. 3-7 to avoid triggering a link integrity failure responsive to a content type switch in which a content type indicator has not been received from the transmitter 105 in a timely manner.

The transmitter 105 can be configured to propagate the content stream indicator to the receiver 115, the repeater 110, and any other downstream devices after authentication. Once authentication has been completed and transmission of the encrypted content has begun, the transmitter 105 can be configured to send a content type indicator to the downstream devices responsive to a change in content. However, the content type indicator may be sent using out of band techniques in which the content type indicator is not included in the encrypted content stream being transmitted by the transmitter 105. Accordingly, it is possible for the content type indicator to arrive either before or after content of the this content type arrives at the receiver 115 or the repeater 110. The HDCP 2.2 on DP 1.3 specification does not specifically address the propagation of the content type indicator to the receiver 115 or the repeater 110 after the transmission of the encrypted content stream has already commenced. However, the techniques disclosed herein address this situation and can be used to prevent interruption of the playback of the encrypted content resulting from a content type indicator being delayed in reaching the downstream devices.

A number of software modules and data tables can reside in memory 215 and can be utilized by the processor 210 in order to manage both communications with other devices, and/or perform the various digital content management processes disclosed herein. As illustrated in FIG. 2, in some embodiments, the memory 215 can include an application module 220 which can implement one or more applications. It is to be noted that the functionality of the modules and/or data structures can be combined, separated, and/or be structured in different ways depending upon the implementation of the computing device 200.

The application module 220 can be a process running on the processor 210 of the computing device 200, which can request information from the application module 220 or other data from one of the other modules of the computing device 200. Applications typically run within an upper layer of the software architectures and can be implemented in a rich execution environment of the computing device 200. The application module 220 can be configured to perform one or more of the processes disclosed herein. Furthermore, the application module 220 can be configured to be an upstream content control function that serves as a source of digital content similar to the upstream content control unit 275.

The processor 210 can include a trusted execution environment 280 and/or the computing device 200 may include a secure component 290. The trusted execution environment 280 and/or the secure component 290 can be used to implement at least a portion of the processes disclosed herein. The trusted execution environment 280 and/or the secure component 290 can be used to provide a secure computing environment for implementing the encryption and/or decryption of the digital content and for storage of encryption keys that can prevent an unauthorized party from tampering with and/or potentially circumventing the content protection protocols disclosed herein.

The trusted execution environment 280 can be implemented as a secure area of the processor 210 that can be used to process and store sensitive data. The trusted execution environment 280 can be configured to execute trusted applications that provide end-to-end security for sensitive data by enforcing confidentiality, integrity, and protection of the sensitive data stored therein. The trusted execution environment 280 can be used to store encryption keys, secure application program code, and/or other sensitive information.

The computing device 200 can include a secure component 290 (also referred to herein as a trusted component). The computing device can include the secure component 290 in addition to or instead of the trusted execution environment 280. The secure component 290 can comprise autonomous and tamper-resistant hardware that can be used for implementing the encryption and/or decryption of the digital content and for storage of encryption keys that can prevent an unauthorized party from tampering with and/or potentially circumventing the content protection protocols disclosed herein. The secure component 290 can be configured to store sensitive data and to provide confidentiality, integrity, and protection to the data stored therein. The secure component 290 can be used to store encryption keys, user data, and/or other sensitive data. The secure component 290 can be integrated with the hardware of the computing device in a permanent or semi-permanent fashion can be used to securely store data and/or provide a secure execution environment for applications.

The computing device 200 can further include a user interface 250 providing suitable interface systems, such as a microphone/speaker 255, a keypad 260, and a display 265 that allows user interaction with the computing device 200. The microphone/speaker 255. The keypad 260 can comprise suitable buttons for user input. The display 265 can include a suitable display, such as, for example, a backlit LCD display, and can further include a touch screen display for additional user input modes.

FIG. 3 is a flow chart of an example process for operating a receiver according to the techniques disclosed herein. The process illustrated in FIG. 3 can be used to provide a user of the receiver with a better user experience by avoiding link integrity errors resulting from changes in content type of a digital content stream being received by the receiver before receiving notification of such a change in content type from the transmitter. The process illustrated in FIG. 3 can be implemented by the receiver 115 or by the repeater 110 illustrated in FIG. 1. The content processing unit 270 of the receiver or repeater can provide the means for implementing the various stages of the process illustrated in FIG. 3 unless otherwise specified.

A content type indicator can be received from a transmitter indicating that a content stream from the transmitter comprises a first content type (stage 305). The content processing unit 270 of the receiver or repeater can be configured to receive, via the media interface 225 or the network interface 205 of the receiver or repeater. In some implementations, the transmitter 105 can be configured to send a content type indicator to the downstream devices, such as the repeater 110 and the receiver 115. The content type is assigned by the upstream content control unit 275 of the most upstream transmitter. In the examples illustrated herein, two content types are possible: non-premium content and premium content. However, the techniques disclosed herein are not limited to two content types and may include more than two types of content. Furthermore, the techniques disclosed herein are not limited to these two specific content types. Other implementations can utilize other content types depending upon the content protection protocol or protocols implemented by the transmitter, receiver, and optional repeaters that may are utilized in a particular implementation.

A particular content protection protocol can impose limitations on how different types of content stream are to be handled by the transmitter, receiver, and repeater. The content protection protocol can require that a certain version or higher of a the content protection protocol be utilized for processing. For example, the transmitter, receiver, and repeater (where one or more repeaters are included) can be configured to implement HDCP version 2.2 on DisplayPort version 1.3. The transmitter, receiver, and repeater(s) can be configured to utilize a shared type value indicator that serves as a content type indicator for the type content being transmitted by the transmitter. According to the HDCP 2.2 on DP 1.3 specifications, two content types may be transmitted: type 0 which is non-premium content, and type 1 which is premium content. Non-premium content can be transmitted by a transmitter or a repeater to all devices supporting any version of HDCP. Premium content cannot be transmitted to HDCP 1.x compliant receivers or to HDCP 2.0 compliant repeaters. Premium content can be transmitted to receivers and repeaters supporting higher versions of the HDCP protocol, such as but not limited to HDCP 2.2. HDCP on DisplayPort is an example of one possible implementation. The techniques disclosed herein are not limited to these specific protocols or combination of protocols.

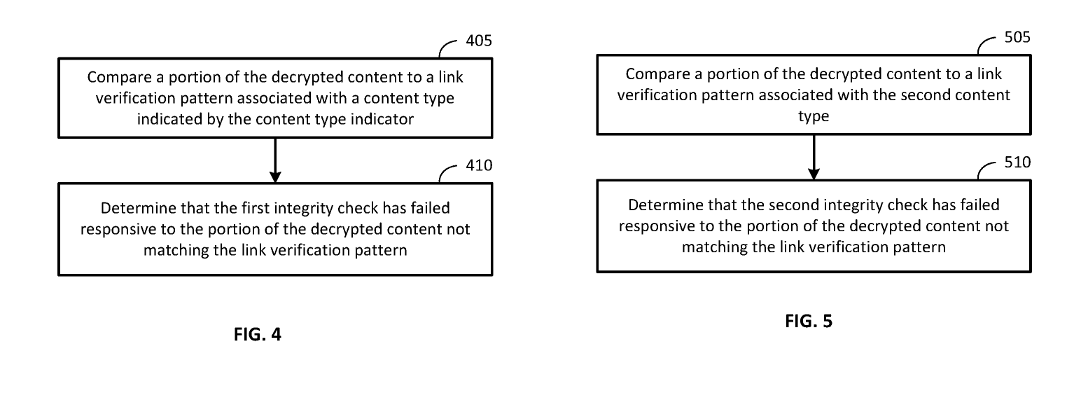

A first integrity check can be performed on the content stream by decrypting content from the content stream based in part on the content type indicator (stage 310). The content processing unit 270 of the receiver or repeater can be configured to perform an integrity check on the content stream by decrypting at least a portion of the content stream and comparing the decrypted value to an expected value. If the decrypted value matches the expected value, then the ciphers of the transmitter and the receiver are synchronized. If the decrypted value does not match the expected value, then the content processing unit 270 of the receiver or repeater can be configured to raise an link integrity error with the receiver. FIG. 4, discussed in detail below, illustrates an example of one type of integrity check that can be implemented by the content processing unit 270. The initialization vector used by the content processing unit 270 of the receiver or repeater to decrypt the digital content received from the upstream device can be dependent on the type of content being transmitted by the received. As discussed above, the content type indicator can be used can be used to determine one or more bits of the IV that is used to encrypt the digital content. A type mismatch can occur where the transmitter has changed the type of content being transmitted to the downstream devices, but the receiver or repeater receiving this digital content has not yet been informed of the content type change. As a result, the content processing unit 270 can utilize the wrong IV for decrypting the encrypted content stream.

As discussed above, HDCP 2.2 on DP 1.3 uses AES-CTR to encrypt the digital content stream. The content indicator type is one of the inputs used to determine the initialization vector (IV) used for encrypting the content stream. Accordingly, if the transmitter 105 does not inform the repeater 110 or receiver 115 downstream from the transmitter of a change in content type, the downstream device(s) may utilize the wrong IV value when attempting to decrypt the encrypted content. However, the HDCP 2.2 on DP 1.3 specification does not indicate how the transmitter 105 is inform downstream devices of a change in the type of content being transmitted to the receiver 115 or repeater 110 once authentication has been performed with the transmitter 105 and a the receiver 115 or repeater 110. The transmitter 105 can be configured to send a content type indicator to the receiver 115 or repeater 110 using an out-of-band communication method in which changes to the content type indicator are not propagated with the content stream.

A counter can be incremented responsive to the first integrity check failing due to a mismatch between the content type indicator and the content of the content stream (stage 315). The content processing unit 270 can be configured to maintain a mismatch counter that is incremented each time that a type mismatch occurs. The content processing unit 270 can be configured to reset the mismatch counter responsive to an integrity check being successfully completed. The content processing unit 270 can also be configured to reset the mismatch counter responsive to receiving a content type indicator from the transmitter 105.

A second integrity check can be performed on the content stream by decrypting the content from the content stream based in part on a second content type responsive to the counter exceeding a threshold (stage 320). The content processing unit 270 can be configured to perform an integrity check on the content stream using a second content type that is different from the first content type. FIG. 5, discussed in detail below, illustrates an example of one type of integrity check that can be implemented by the content processing unit 270. The second integrity check can be similar that of the first integrity check of stage 305 but utilizes the second content type when decrypting the digital content. In implementations with only two content types, such as in the HDCP examples discussed herein, the content processing unit 270 can be configured to switch from the content type that was expected to be received in stage 305 to the other content type. In HDCP 2.2 on DP 1.3, if premium content was expected to be received in stage 305, the content processing unit 270 can be configured to switch to using the non-premium content type indicator when decrypting the digital content or vice versa. In implementations where there are more than two types of content that may be received from the transmitter 105, the content processing unit 270 of the receiver can be configured to select an expected content type that is most likely to be received. For example, the content processing unit 270 of the receiver can be configured to select a content type based on the frequency that the transmitter 105 has transmitted each type of content in a particular content stream or more than one content steams, and can select the a most frequent content type that is different than the expected content type from stage 305 for performing the second integrity check in stage 315.

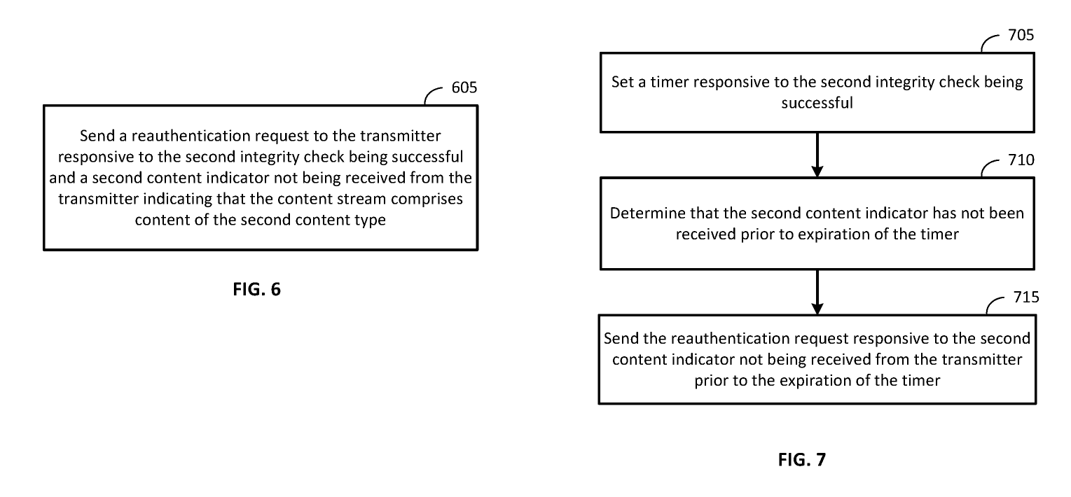

The content stream can be decrypted based in part on the second integrity check being successful (stage 325). The content processing unit 270 can be configured to continue to decrypt the content stream based on the second content type responsive to the integrity check passing using the second content type. The content processing unit 270 can be configured to use the second content type to generate the correct initialization vector for decrypting the content as discussed above. The content processing unit 270 can be configured to continue to decrypt the content using the second content type for a limited period of time or until a content type indicator is received from the transmitter 105 indicating that a content type change. The content processing unit 270 of the receiver can be configured to trigger a reauthentication process with the transmitter 105 responsive to a content type indicator not being received within a predetermined time of switching to the second content type. An example of such processes are illustrated in FIGS. 6 and 7.

FIG. 4 is a flow chart of an example process for performing an integrity check on digital content at a receiver according to the techniques disclosed herein. The process illustrated in FIG. 4 can be used to implement, at least in part, stage 310 of the process illustrated in FIG. 3. The process illustrated in FIG. 4 can be implemented by the receiver 115 or by the repeater 110 illustrated in FIG. 1. The content processing unit 270 of the receiver or repeater can provide the means for implementing the various stages of the process illustrated in FIG. 4 unless otherwise specified.

A portion of the decrypted content can be compared to a link verification pattern associated with a content type indicated by the content type indicator (stage 405). The content processing unit 270 of the receiver 115 or repeater 110 can be configured to decrypt the digital content stream received of the transmitter 105 and to extract a link verification pattern from the decrypted content. The link verification pattern includes an expected pattern of data that, if recovered from the decrypted content stream, is indicative of the content having been decrypted successfully by the content processing unit 270 of the receiver 115 or repeater 110. In HDCP 2.2 on DP 1.3 implementations, the link verification pattern is transmitted during a blanking interval. However, in other implementations, the link verification pattern may be transmitted at a different point in the content stream.

The content processing unit 270 of the receiver 115 or repeater 110 can compare the link verification pattern to an expected value to determine whether content stream has been received and decrypted successfully. As discussed above, the initialization vector used to encrypt the digital content is dependent at least in part on the content type indicator associated with the content type being transmitted by the transmitter 105. The content processing unit 270 of the receiver 115 or repeater 110 can be configured to utilize this information to determine whether the content type that the content processing unit 270 of the receiver 115 or repeater 110 is expecting to receive is actually included in the content stream. The link verification pattern extracted from the decrypted should match the expected value responsive to the content processing unit 270 selecting the appropriate initialization vector based on the expected content type.

A determination that the first integrity check has failed can be made responsive to the portion of the decrypted content not matching the link verification pattern (stage 410). The content processing unit 270 of the receiver 115 or repeater 110 can be configured to determine that the integrity check has failed in response the link verification pattern not matching the portion of the decrypted content. The content processing unit 270 of the receiver 115 or repeater 110 can be configured to determine that the integrity check has been successful in response the link verification pattern matching the portion of the decrypted content.

FIG. 5 is a flow chart of an example process for performing an integrity check on digital content at a receiver according to the techniques disclosed herein. The process illustrated in FIG. 4 can be used to implement, at least in part, stage 320 of the process illustrated in FIG. 3. The process illustrated in FIG. 4 can be implemented by the receiver 115 or by the repeater 110 illustrated in FIG. 1. The content processing unit 270 of the receiver or repeater can provide the means for implementing the various stages of the process illustrated in FIG. 5 unless otherwise specified.

A portion of the decrypted content can be compared to a link verification pattern associated with the second content type (stage 505). Stage 505 is similar to that of stage 405 of the process of FIG. 4, except that a portion of the digital content stream that has been decrypted using the content type indicator associated with the second content type in the stage 505 rather than the content type indicator associated with the second content type in the stage 405.

A determination that the second integrity check has failed can be made responsive to the portion of the decrypted content not matching the link verification pattern (stage 510). Stage 510 is similar to that of stage 410 of the process illustrated in FIG. 4. The content processing unit 270 of the receiver 115 or repeater 110 can be configured to determine that the integrity check has failed in response the link verification pattern not matching the portion of the decrypted content. The content processing unit 270 of the receiver 115 or repeater 110 can be configured to determine that the integrity check has been successful in response the link verification pattern matching the portion of the decrypted content. The content processing unit 270 of the receiver 115 or repeater 110 can be configured to continue decrypting the digital content using the second content type responsive to the link integrity check being successful. The transmitter 105 may have changed the content type being transmitted in the digital content stream and the receiver 115 or the repeater 110 may not have yet received the content type indicator from the transmitter 105 indicating that the content type has changed. The content processing unit 270 can be configured to initiate a reauthorization process, such as that illustrated in FIGS. 6 and 7, and discussed in detail below, responsive to the second integrity check failing. In some implementations, the content processing unit 270 can be configured to perform the integrity check using one or more additional content types in an attempt to determine the current content type of the content stream before initiating the reauthorization process.

FIG. 6 is a flow chart of an example process for performing reauthentication between the receiver or repeater and the transmitter according to the techniques disclosed herein. The process illustrated in FIG. 6 can be used to implement, at least in part, additional stages of the process illustrated in FIG. 3. The process illustrated in FIG. 6 can be implemented by the receiver 115 or by the repeater 110 illustrated in FIG. 1. The content processing unit 270 of the receiver or repeater can provide the means for implementing the various stages of the process illustrated in FIG. 6 unless otherwise specified.

A reauthentication request can be sent to the transmitter responsive to the second integrity check being successful and a second content indicator not being received from the transmitter indicating that the content stream comprises content of the second content type (stage 605). The content processing unit 270 of the receiver 115 or repeater 110 can be configured to continue using the second content type to determine the initialization vector for decrypting the content stream received from the transmitter 105 for a predetermined period of time before initiating the a reauthentication with the transmitter 105. For example, the content processing unit 270 of the receiver 115 or repeater 110 can be configured to can be configured to set a timer responsive to the second integrity check of stage 320 of the process of FIG. 3 or of FIG. 5 being successful. The receiver 115 or repeater 110 can be configured to utilize the second content type for a period of time without being notified by the transmitter of a content type change in order to avoid interrupting the playback of the content stream and adversely affecting the user experience. For example, in implementations of HDCP 2.2 on DP 1.3, the receiver 115 or repeater 110 would have raised a link integrity error responsive to the content type of the content stream being out of synchronization with the expected content type. The receiver 115 or the repeater 110 would have sent an link integrity error message to the transmitter 105, which would have initiated a reauthentication procedure with the transmitter 105. The authentication procedure typically takes several seconds to complete and would result in the playback of the content stream being interrupted until the authentication procedure was completed. The user may experience a blank or black screen during this time, which adversely affects the user experience.

FIG. 7 is a flow chart of an example process for performing reauthentication between the receiver or transmitter and the transmitter according to the techniques disclosed herein. The process illustrated in FIG. 6 can be used to implement, at least in part, stage 605 of the process illustrated in FIG. 6. The process illustrated in FIG. 7 can be implemented by the receiver 115 or by the repeater 110 illustrated in FIG. 1. The content processing unit 270 of the receiver or repeater can provide the means for implementing the various stages of the process illustrated in FIG. 7 unless otherwise specified.

A timer can be set responsive to the second integrity check being successful (stage 705). The content processing unit 270 of the receiver or repeater can be configured to set a timer responsive to the second integrity check being successful. The second integrity check is performed by the content processing unit 270 responsive to the first integrity check failing and the content processing unit 270 switching to a different expected content type. The success of the second integrity check is indicative of the type of content included in the content stream being transmitted by the transmitter 105 has changed from the first content type to the second content type. For example, in HCDP 2.2 implementation, the change in content type can indicate that the transmitter 105 is now transmitted premium content while the receiver 115 or the repeater 110 is expecting non-premium content or vice versa.

The content processing unit 270 can also be configured to implement a counter instead of or in addition to a timer. The content processing unit 270 can be configured to maintain a counter value in memory 215 or another readable and writeable memory of the device. The content processing unit 270 can be configured to increment the counter responsive to a number of frames of data or other logical delimiter of the content of the content stream having been received at the content processing unit 270 of the receiver 115 or repeater 110.

A determination can be made that the second content indicator has not been received prior to expiration of the timer (stage 710). The content processing unit 270 of the receiver 115 or the repeater 110 can be configured to determine that the transmitter 105 has not provided an indication that the content type included in the content stream has changed prior to the expiration of the timer maintained by the content processing unit 270 or responsive to the counter reaching a predetermined value.

The reauthentication request can be sent responsive to the second content indicator not being received from the transmitter prior to the expiration of the timer (stage 715). The content processing unit 270 of the receiver 115 or the repeater 110 can be configured to send a reauthentication request to the transmitter 105 responsive to the second content indicator not being received from the transmitter prior to the expiration of the timer and/or the counter reaching the predetermined value. The timer and/or counter can be reset responsive to the reauthentication request being transmitted to the receiver or responsive to the second content indicator being received prior to expiration of the timer and/or the counter reaching the predetermined value.

In HDCP 2.2 on DP 1.3 implementations, the receiver 115 or repeater 110 is configured to determine that a link integrity failure has occurred if pattern mismatches between the link verification pattern obtained from a portion of the decrypted content stream and the expected link verification pattern are detected for two successive link frame periods when operating in MST mode or three successive pattern mismatches have occurred within two successive frame periods. Two periods are checked to allow for recovery from simple transient synchronization errors. Failures in excess of this amount are considered to be non-recoverable loss of cipher synchronization errors that require reauthentication under the standard. The content processing unit 270 of the receiver 115 or repeater 110 can assert a link integrity failure bit in a receiver status register and generate an interrupt that causes the transmitter 105 to read the receiver status register to determine the cause of the interrupt. The transmitter 105 is configured to disable encryption as soon as possible after receiving the interrupt and to initiate a reauthentication with the receiver 115 or the repeater 110. According to the techniques disclosed herein, the content processing unit 270 of the receiver is configured to attempt to avoid a link integrity error from being raised and reauthentication where there is a delay in the content type indicator reaching the receiver 115 or the repeater 110 by waiting an additional period of time for the content type indicator to be received responsive to a type mismatch occurring but the content processing unit 270 of the receiver is able to successfully decrypt the content stream using the second content type. This approach can provide a better user experience by avoiding unnecessarily performing reauthentication where a content type switch has occurred, because the reauthentication process can interrupt playback of the digital content for several seconds while the reauthentication is performed.

Computer programs (also known as programs, software, software applications or code) include machine instructions for a programmable processor, and may be implemented in a high-level procedural and/or object-oriented programming language, and/or in assembly/machine language. As used herein, the terms “processor-readable medium” and “machine-readable medium” refer to any non-transitory computer program product, apparatus and/or device (e.g., magnetic discs, optical disks, memory, Programmable Logic Devices (PLDs)) used to provide machine instructions and/or data to a programmable processor, including a non-transitory machine-readable medium that receives machine instructions as a machine-readable signal.

Memory may be implemented within the computing-based device or external to the device. As used herein the term “memory” refers to any type of long term, short term, volatile, nonvolatile, or other memory and is not to be limited to any particular type of memory or number of memories, or type of media upon which memory is stored.

If implemented in-part by hardware or firmware along with software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage, semiconductor storage, or other storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate in the context of the systems, devices, circuits, methods, and other implementations described herein.

As used herein, including in the claims, “or” as used in a list of items prefaced by “at least one of” or “one or more of” indicates a disjunctive list such that, for example, a list of “at least one of A, B, or C” means A or B or C or AB or AC or BC or ABC (i.e., A and B and C), or combinations with more than one feature (e.g., AA, AAB, ABBC, etc.). Also, as used herein, unless otherwise stated, a statement that a function or operation is “based on” an item or condition means that the function or operation is based on the stated item or condition and may be based on one or more items and/or conditions in addition to the stated item or condition.

As used herein, a mobile device or station (MS) refers to a device such as a cellular or other wireless communication device, a smartphone, tablet, personal communication system (PCS) device, personal navigation device (PND), Personal Information Manager (PIM), Personal Digital Assistant (PDA), laptop or other suitable mobile device which is capable of receiving wireless communication and/or navigation signals, such as navigation positioning signals. The term “mobile station” (or “mobile device” or “wireless device”) is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, “mobile station” is intended to include all devices, including wireless communication devices, computers, laptops, tablet devices, etc., which are capable of communication with a server, such as via the Internet, WiFi, or other network, and to communicate with one or more types of nodes, regardless of whether satellite signal reception, assistance data reception, and/or position-related processing occurs at the device, at a server, or at another device or node associated with the network. Any operable combination of the above are also considered a “mobile station.” A mobile device may also be referred to as a mobile terminal, a terminal, a user equipment (UE), a device, a Secure User Plane Location Enabled Terminal (SET), a target device, a target, or by some other name.

While some of the techniques, processes, and/or implementations presented herein may comply with all or part of one or more standards, such techniques, processes, and/or implementations may not, in some embodiments, comply with part or all of such one or more standards.

What is claimed:

1. A method for operating a receiver, the method comprising:
receiving a content type indicator from a transmitter indicating that a content stream from the transmitter comprises a first content type;
performing a first integrity check on the content stream by decrypting content from the content stream based in part on the content type indicator;
incrementing a counter responsive to the first integrity check failing due to a mismatch between the content type indicator and the content of the content stream;
performing a second integrity check on the content stream by decrypting the content from the content stream based in part on a second content type responsive to the counter exceeding a threshold; and
decrypting the content stream based in part on the second integrity check being successful.

2. The method of claim 1, wherein the content type indicator indicates whether the content stream comprises premium content.

3. The method of claim 1, wherein the content stream is encrypted using High-bandwidth Digital Content Protection (HDCP).

4. The method of claim 3, wherein the content stream is encrypted with a version 2.2 of HDCP or higher.

5. The method of claim 1, wherein performing the first integrity check on the content stream by decrypting the content from the content stream based in part on the content type indicator comprises:
comparing a portion of decrypted content to a link verification pattern associated with a content type indicated by the content type indicator; and
determining that the first integrity check has failed responsive to the portion of the decrypted content not matching the link verification pattern.

6. The method of claim 1, wherein performing the second integrity check on the content stream by decrypting the content from the content stream based on part on the second content type further comprises:
comparing a portion of the decrypted content to a link verification pattern associated with the second content type; and
determining that the second integrity check has failed responsive to the portion of the decrypted content not matching the link verification pattern.

7. The method of claim 1, further comprising:
sending a reauthentication request to the transmitter responsive to the second integrity check being successful and a second content indicator not being received from the transmitter indicating that the content stream comprises content of the second content type.

8. The method of claim 7, wherein sending the reauthentication request to the transmitter further comprises:
setting a timer responsive to the second integrity check being successful;
determining that the second content indicator has not been received prior to expiration of the timer; and
sending the reauthentication request responsive to the second content indicator not being received from the transmitter prior to the expiration of the timer.

9. A receiver comprising:
means for receiving a content type indicator from a transmitter indicating that a content stream from the transmitter comprises a first content type;
means for performing a first integrity check on the content stream by decrypting content from the content stream based in part on the content type indicator;
means for incrementing a counter responsive to the first integrity check failing due to a mismatch between the content type indicator and the content of the content stream;
means for performing a second integrity check on the content stream by decrypting the content from the content stream based in part on a second content type responsive to the counter exceeding a threshold; and
means for decrypting the content stream based in part on the second integrity check being successful.

10. The receiver of claim 9, wherein the content type indicator indicates whether the content stream comprises premium content.

11. The receiver of claim 9, wherein the content stream is encrypted using High-bandwidth Digital Content Protection (HDCP) and version 2.2 of the HDCP protocol or higher.

12. The receiver of claim 9, wherein the means for performing the first integrity check on the content stream by decrypting the content from the content stream based in part on the content type indicator further comprises:
means for comparing a portion of the decrypted content to a link verification pattern associated with a content type indicated by the content type indicator; and
means for determining that the first integrity check has failed responsive to the portion of the decrypted content not matching the link verification pattern.

13. The receiver of claim 9, wherein the means for performing the second integrity check on the content stream by decrypting the content from the content stream based on part on the second content type further comprises:
means for comparing a portion of the decrypted content to a link verification pattern associated with the second content type; and
means for determining that the second integrity check has failed responsive to the portion of the decrypted content not matching the link verification pattern.

14. The receiver of claim 9, further comprising:
means for sending a reauthentication request to the transmitter responsive to the second integrity check being successful and a second content indicator not being received from the transmitter indicating that the content stream comprises content of the second content type.

15. The receiver of claim 14, wherein the means for sending the reauthentication request to the receiver further comprises:
means for setting a timer responsive to the second integrity check being successful;
means for determining that the second content indicator has not been received prior to expiration of the timer; and
means for sending the reauthentication request responsive to the second content indicator not being received from the transmitter prior to the expiration of the timer.

16. A receiver comprising:
a memory; and
a processor communicatively coupled to the memory and configured to:
receive a content type indicator from a transmitter indicating that a content stream from the transmitter comprises a first content type;
perform a first integrity check on the content stream by decrypting content from the content stream based in part on the content type indicator;
increment a counter responsive to the first integrity check failing due to a mismatch between the content type indicator and the content of the content stream;
perform a second integrity check on the content stream by decrypting the content from the content stream based in part on a second content type responsive to the counter exceeding a threshold; and
decrypt the content stream based in part on the second integrity check being successful.

17. The receiver of claim 16, wherein the content type indicator indicates whether the content stream comprises premium content.

18. The receiver of claim 16, wherein the processor being configured to perform the first integrity check on the content stream by decrypting content from the content stream based in part on the content type indicator further is further configured to:
compare a portion of the decrypted content to a link verification pattern associated with a content type indicated by the content type indicator; and
determine that the first integrity check has failed responsive to the portion of the decrypted content not matching the link verification pattern.

19. The receiver of claim 16, wherein the processor being configured to perform the second integrity check on the content stream by decrypting content from the content stream based on part on the second content type is further configured to:
compare a portion of the decrypted content to a link verification pattern associated with the second content type; and
determine that the second integrity check has failed responsive to the portion of the decrypted content not matching the link verification pattern.

20. The receiver of claim 16, wherein the processor is further configured to:
send a reauthentication request to the transmitter responsive to the second integrity check being successful and a second content indicator not being received from the transmitter indicating that the content stream comprises content of the second content type.

21. The receiver of claim 20, wherein the processor being configured to send the reauthentication request is further configured to:
set a timer responsive to the second integrity check being successful;
determine that the second content indicator has not been received prior to expiration of the timer; and
send the reauthentication request responsive to the second content indicator not being received from the transmitter prior to the expiration of the timer.

22. A non-transitory, computer-readable medium, having stored thereon computer-readable instructions operating for operating a receiver, comprising instructions configured to cause the receiver to:
receive a content type indicator from a transmitter indicating that a content stream from the transmitter comprises a first content type;
perform a first integrity check on the content stream by decrypting content from the content stream based in part on the content type indicator;
increment a counter responsive to the first integrity check failing due to a mismatch between the content type indicator and the content of the content stream;
perform a second integrity check on the content stream by decrypting the content from the content stream based in part on a second content type responsive to the counter exceeding a threshold; and
decrypt the content stream based in part on the second integrity check being successful.

23. The non-transitory, computer-readable medium of claim 22, wherein the content type indicator indicates whether the content stream comprises premium content.

24. The non-transitory, computer-readable medium of claim 22, wherein the content stream is encrypted using High-bandwidth Digital Content Protection (HDCP) and version 2.2 of the HDCP protocol or higher.

25. The non-transitory, computer-readable medium of claim 22, wherein the instructions configured to cause the receiver to perform the first integrity check on the content stream by decrypting content from the content stream based in part on the content type indicator further comprise instructions configured to cause the receiver to:
compare a portion of the decrypted content to a link verification pattern associated with a content type indicated by the content type indicator; and
determine that the first integrity check has failed responsive to the portion of the decrypted content not matching the link verification pattern.

26. The non-transitory, computer-readable medium of claim 22, wherein the instructions configured to cause the receiver to perform the second integrity check on the content stream by decrypting content from the content stream based on part on the second content type further comprise instructions configured to cause the receiver to:
compare a portion of the decrypted content to a link verification pattern associated with the second content type; and
determine that the second integrity check has failed responsive to the portion of the decrypted content not matching the link verification pattern.

27. The non-transitory, computer-readable medium of claim 22, further comprising instructions configured to cause the receiver to:
send a reauthentication request to the transmitter responsive to the second integrity check being successful and a second content indicator not being received from the transmitter indicating that the content stream comprises content of the second content type.

28. The non-transitory, computer-readable medium of claim 27, wherein the instructions configured to cause the receiver to send the reauthentication request to the transmitter further comprise instructions configured to cause the receiver to:
set a timer responsive to the second integrity check being successful;
determine that the second content indicator has not been received prior to expiration of the timer; and
send the reauthentication request responsive to the second content indicator not being received from the transmitter prior to the expiration of the timer.
